(19) United States
(12) Patent Application Publication
(10) Pub. No.: US 2002/0062295 A1
(43) Pub. Date: May 23, 2002

(54) Method and apparatus for evaluating polynomials and rational functions

(75) Inventors: Robert F. Enenkel, Don Mills (CA); Sigitas Keras, Toronto (CA)

Correspondence Address: A. Bruce Clay, IBM Corporation T81/503, PO Box 12195, Research Triangle Park, NC, 27709, US

(73) Assignee: International Business Machines Corporation, Armonk, NY

(21) Appl. No.: 10/008,473

(22) Filed: Nov. 9, 2001

(30) Foreign Application Priority Data
Oct. 11, 2000 (CA) 2325615

(51) Int. Cl. G06F 15/18

(52) U.S. Cl. 706/12

(57) ABSTRACT

Disclosed herein are a computer-processing method and apparatus for computing values of polynomials or rational functions. A mathematical software library can advantageously embody the concepts of this invention. The method can be adapted to compute values for non-elementary,special functions, for example ERF, ERFC, LGAMMA, and Bessel functions. The steps for polynomial evaluation include presenting input data that includes coefficients of polynomial p(x), x, a predetermined xᵢ, and p(xᵢ), building polynomial c(x) having coefficients so that polynomial p(x) is expressible as:

p(x)=p(xᵢ)+{x−xᵢ}·c(x),

determining each coefficient of polynomial c(x), determining a value of polynomial c(x), and constructing a value of polynomial p(x) by determining:

p(x)=p(xᵢ)+{x−xᵢ}·c(x).

The method can be adapted for providing a value for a rational function

r(x)=p(x)/q(x),

which is a ratio of a numerator polynomial p(x) and a denominator polynomial q(x).

### FIELD OF THE INVENTION

The present invention relates to a method and apparatus for computing values of mathematical expressions, and more specifically to a computer processing method and computer apparatus for computing binary representations of numerical values of polynomials and rational functions.

### BACKGROUND OF THE PRESENT INVENTION

Polynomials and rational functions, which are quotients of polynomials, are used, for example, by various branches of applied science for determining numerical values of mathematical expressions for modeling a property of a physical system, for example a rate of air flow over an airfoil surface. Polynomials can be used to approximate complicated mathematical expressions. Various methods, for example Homer's Rule that was disclosed in 1819, are used for computing values of polynomials, and provide a degree of accuracy that may not be acceptable in certain situations, depending on the particular polynomial and the accuracy required. G. E. Forsythe et al in “Computer Methods for Mathematical Computations” Prentice-Hall (1977) discloses, in Section 4.2, using Homer's Rule for computing a numerical value of a polynomial.

Steps for computing binary representations of numbers can create an unacceptably large deviation between a computed binary representation and its theoretical numerical value due to successive rounding errors. This can be an intolerable situation when a higher degree of accuracy is required. Various methods can improve computation accuracy but they may require a significant increase in processing time and/or hardware.

Agarwal et al in “New Scalar and Vector Elementary Functions for the IBM System/370” IBM Journal of Research and Development: Vol.30 No.2 (March 1986), and Gal et al in “An Accurate Elementary Mathematical Library for the IEEE Floating Point Standard” ACM Transactions on Mathematical Software Vol.17 No.1 (March 1991) pp. 26 to 45, appear to disclose methods that include a lookup table having non-equidistantly spaced entries for computing values for elementary mathematical functions.

Markstein in “Computation of Elementary Functions on the IBM RISC System/6000 Processor” IBM Journal of Research and Development Vol.34 No.1 (January 1990) appears to disclose a method for computing values of a function g(x) near a given point xᵢ.

Gustavson et al in “Elementary Function Subroutines” Department of Mathematical Sciences of IBM Watson Research Center (January 1985) appears to disclose a program implementation for a software mathematical library.

### OBJECT OF THE PRESENT INVENTION

An object of the present invention is to obviate the disadvantages of the prior art.

### SUMMARY OF THE PRESENT INVENTION

A first aspect of the present invention provides a machine-processing method for computing a property of a mathematically modelled physical system, the steps including: reading, via a machine processing unit, input data including a value for each identified ordered coefficient of a first polynomial p(x) representing the property, the polynomial p(x) being expressed as

p(x)=Σ(Pⱼ·x^{j}) where j=0 to n,

a value of a quantity x, a value of a predetermined xᵢ, and a value of a predetermined p(x) correspondingly paired with said predetermined xᵢ; building, via the machine processing unit, a value of a second polynomial c(x) having ordered coefficients, the second polynomial c(x) being expressible as:

c(x)=Σ(Cₖ·x^{k}) where k=0 to (n−1)

so that the first polynomial p(x) is expressible as:

p(x)=p(xᵢ)+{x−xᵢ}·c(x),

including the steps of: determining, via the machine processing unit, a value for each ordered coefficient of the second polynomial c(x) by generating a plurality of machine processing unit signals to determine each of the ordered coefficients of the second polynomial c(x) from:

Cₖ=Σ(P₍ₖ₊₁₊ⱼ₎·xⱼⁱ) where j=0 to (n−1−k);

determining, via the machine processing unit, a value of the second polynomial c(x) by generating a plurality of machine processing unit signals to determine:

c(x)=Σ(Cₖ·x^{k}) where k=0 to (n−1);

and constructing, via the machine processing unit, a value of the first polynomial p(x) by generating a plurality of machine processing unit signals to determine

p(x)=p(xᵢ)+{x−xᵢ}·c(x);

and outputting, via the machine-processing unit, the value of the first polynomial p(x) representing said property of the mathematically modelled physical system.

Preferably the machine-implementable method is further adapted so that a difference between x and xᵢ is sufficiently small to achieve a desired accuracy of a final computation of the machine representation of a numerical value of the first polynomial p(x).

Preferably the machine-implementable method is further adapted so that the step of reading the input data includes reading, via the machine processing unit, the input data from a machine-readable medium.

Preferably the machine-implementable method is further adapted so that the ordered coefficients of the second polynomial c(x) are computed from a mathematical expression derivable from:

Cₖ=Σ(P₍ₖ₊₁₊ⱼ₎·xᵢ^{j}) where j=0 to (n−1−k).

Preferably the machine-implementable method is further adapted so that the mathematical expression is a mathematical recurrence expression.

Preferably the machine-implementable method is further adapted so that the mathematical recurrence expression is a forward mathematical recurrence expression.

Preferably the machine-implementable method is further adapted so that the mathematical recurrence expression is a backward mathematical recurrence expression.

Preferably the machine-implementable method is further adapted to implement the backward mathematical recurrence expression by including further steps for: equating, via the machine-processing unit, a value of a highest ordered coefficient of the second polynomial c(x) to a value of an identified highest ordered coefficient of the first polynomial p(x) by generating a plurality of machine processing unit signals to determine:

Cₙ₋₁=Pₙ;

and computing, via a machine processing unit, a value for each lower ordered coefficient of the second polynomial c(x) by generating a plurality of machine processing unit signals to determine:

Cₖ₋₁=xᵢ·Cₖ+Pₖ where k=(n−1) to 1.

Preferably the machine-implementable method is further adapted so that the predetermined xᵢ is selected from a set of predetermined values of xᵢ.

Preferably the machine-implementable method is further adapted so that the predetermined xᵢ is a closest member of the set to the identified x.

Preferably the machine-implementable method is further adapted so that the step of determining a value of the second polynomial c(x) is computed by using Horner's Rule.

Preferably the machine-implementable method is further adapted for determining a value of a denominator polynomial q(x) having identified ordered denominator coefficients, the denominator polynomial q(x) being expressible as:

q(x)=Σ(i Qⱼ·x^{j}) where j=0 to m,

including further steps of: adapting the input data to further include a value for each identified ordered denominator coefficient of the denominator polynomial q(x), a value of a predetermined q(x) correspondingly paired with the predetermined xᵢ; and determining, via the machine processing unit, a value of another polynomial d(x) having ordered denominator coefficients, the another polynomial d(x) being expressible as:

d(x)=Σ(Dₖ·x^{k}) where k=0 to (m−1)

so that the denominator polynomial q(x) is expressible as:

q(x)=q(xᵢ)+{x−xᵢ}·d(x),

and a value for the denominator polynomial is resolved.

Preferably the machine-implementable method is further adapted so that the first polynomialp(x) is a numerator polynomialp(x), and p(x)−p(xᵢ) is computed, and p(xᵢ) is not read.

Preferably the machine-implementable method is further adapted for determining a value of a rational function r(x) being expressible as a quotient of the numerator polynomial p(x) and the denominator polynomial q(x) expressed as

$$r ( x ) = \frac{p ( x )}{q ( x )} ,$$

including further steps of: adapting the input data to further including a value of a predetermined r(xᵢ) correspondingly paired with the predetermined xᵢ; constructing, via the machine processing unit, a value of the rational function r(x) by generating a plurality of machine processing unit signals to determine:

$$r ( x ) = r ( {x}_{i} ) \cdot ( 1 - \frac{q ( x ) - q ( {x}_{i} )}{q ( x )} ) + \frac{p ( x ) - p ( {x}_{i} )}{q ( x )} .$$

Preferably the machine-implementable method is further adapted so that the rational function is an approximation to a Bessel function.

Preferably the machine-implementable method is further adapted so that the rational function is an approximation to an error function (ERF).

Preferably the machine-implementable method is further adapted so that the rational function is an approximation to a complementary error function (ERFC).

Preferably the machine-implementable method is further adapted so that the rational function is an approximation to a log gamma function (LGAMMA).

Preferably the machine-implementable method is further adapted so that all values are machine representations of some numerical value, the machine processing unit is a computer processing unit, and each machine representation is a binary representation operable with the computer processing unit, and the machine-readable medium is a computer-readable medium.

A second aspect of the present invention provides a computer-readable program product having computer executable instructions for instructing a computer, the instructions tangibly embodying the machine-implementable method of the first aspect of the present invention.

A third aspect of the present invention provides a computer-readable mathematical software routine library including computer executable instructions for instructing a computer, the instructions tangibly embodying the machine-implementable method of the first aspect of the present invention.

Preferably, the computer-readable mathematical software routine library is further adapted so that the library is operatively associated with a software programming language.

A fourth aspect of the present invention provides a machine for computing a property of a mathematically modelled physical system, the steps including: reading, via a machine processing unit, input data including a value for each identified ordered coefficient of a first polynomial p(x) representing the property, the polynomial p(x) being expressed as

p(x)=Σ(Pⱼ·x^{j}) where j=0 to n,

a value of a quantity x, a value of a predetermined xᵢ, and a value of a predetermined p(xᵢ) correspondingly paired with the predetermined xᵢ; building, via the machine processing unit, a value of a second polynomial c(x) having ordered coefficients, the second polynomial c(x) being expressible as:

c(x)=Σ(Cₖ·x^{k})where k=0 to (n−1)

so that the first polynomial p(x) is expressible as:

p(x)=p(xᵢ)+{x−xᵢ}·c(x),

including the steps of: determining, via the machine processing unit, a value for each ordered coefficient of the second polynomial c(x) by generating a plurality of machine processing unit signals to determine each of the ordered coefficients of the second polynomial c(x) from:

Cₖ=Σ(P₍ₖ₊₁₊ⱼ₎·xⱼⁱ) where j=0 to (n−1−k);

determining, via the machine processing unit, a value of the second polynomial c(x) by generating a plurality of machine processing unit signals to determine:

c(x)=Σ(Cₖ·x^{k}) where k=0 to (n−1);

constructing, via the machine processing unit, a value of the first polynomial p(x) by generating a plurality of machine processing unit signals to determine :

p(x)=p(xᵢ)+{x−xᵢ}·c(x);

and outputting, via the machine-processing unit, the value of the first polynomial p(x) representing the property of the mathematically modelled physical system.

Preferably, the machine is further adapted so that a difference between x and xᵢ is sufficiently small to achieve a desired accuracy of a final computation of the machine representation of a numerical value of the first polynomial p(x).

Preferably, the machine is further adapted so that the means for reading the input data includes means for reading, via the machine processing unit, the input data from a machine-readable medium.

Preferably, the machine is further adapted so that the ordered coefficients of the second polynomial c(x) are computed from a mathematical expression derivable from:

Cₖ=Σ(P₍ₖ₊₁₊ⱼ₎·xᵢ^{j}) where j=0 to (n−1−k).

Preferably, the machine is further adapted so that the mathematical expression is a mathematical recurrence expression.

Preferably, the machine is further adapted so that the mathematical recurrence expression is a forward mathematical recurrence expression.

Preferably, the machine is further adapted so that the mathematical recurrence expression is a backward mathematical recurrence expression.

Preferably, the machine is further adapted to implement the backward mathematical recurrence expression by further including: means for equating, via the machine processing unit, a value of a highest ordered coefficient of the second polynomial c(x) to a value of an identified highest ordered coefficient of the first polynomial p(x) by generating a plurality of machine processing unit signals to determine:

Cₙ₋₁=Pₙ;

and means for computing, via the machine processing unit, a value for each lower ordered coefficient of the second polynomial c(x) by generating a plurality of machine processing unit signals to determine:

Cₖ₋₁=xᵢ·Cₖ+Pₖ where k=(n−1) to 1.

Preferably, the machine is further adapted so that the predetermined xᵢ is selected from a set of predetermined values of xᵢ.

Preferably, the machine is further adapted so that the predetermined xᵢ is a closest member of the set to the identified x.

Preferably, the machine is further adapted for determining means for determining a value of the second polynomial c(x) is computed by using Homer's Rule.

Preferably, the machine is further adapted for determining a value of a denominator polynomial q(x) having identified ordered denominator coefficients, the denominator polynomial q(x) being expressible as:

q(x)=Σ(Qⱼ·x^{j}) where j=0 to m,

including further steps of: adapting the input data to further include a value for each identified ordered denominator coefficient of the denominator polynomial q(x), and a value of a predetermined q(xᵢ) correspondingly paired with the predetermined xᵢ; and determining, via the machine processing unit, a value of another polynomial d(x) having ordered denominator coefficients, the another polynomial d(x) being expressible as:

d(x)=Σ(Dₖ·x^{k}) where k=0 to (m−1)

so that the denominator polynomial q(x) is expressible as:

q(x)=q(xᵢ)+{x−xᵢ}·d(x),

and a value for the denominator polynomial is resolved.

Preferably, the machine is further adapted so that the first polynomial p(x) is a numerator polynomial p(x), and p(x)−p(xᵢ) is computed, and p(xᵢ) is not read.

Preferably, the machine is further adapted for determining a value of a rational function r(x) being expressible as a quotient of the numerator polynomial p(x) and the denominator polynomial q(x) expressed as

$$r ( x ) = \frac{p ( x )}{q ( x )} ,$$

including further steps of: adapting the input data to further including a value of a predetermined r(xᵢ) correspondingly paired with the predetermined xᵢ; and constructing, via the machine processing unit, a value of the rational function r(x) by generating a plurality of machine processing unit signals to determine:

$$r ( x ) = r ( {x}_{i} ) \cdot ( 1 - \frac{q ( x ) - q ( {x}_{i} )}{q ( x )} ) + \frac{p ( x ) - p ( {x}_{i} )}{q ( x )} .$$

Preferably, the machine is further adapted so that the rational function is an approximation to a Bessel function.

Preferably, the machine is further adapted so that the rational function is an approximation to an error function (ERF).

Preferably, the machine is further adapted so that the rational function is an approximation to a complementary error function (ERFC).

Preferably, the machine is further adapted so that the rational function is an approximation to a log gamma function (LGAMMA).

Preferably, the machine is further adapted so that all values are machine representations of some numerical value, the machine processing unit is a computer processing unit, each machine representation is a binary representation operable with the computer processing unit, and the machine-readable medium is a computer-readable medium.

A fifth aspect of the present invention provides a machine having a computer-readable program product having computer executable instructions for instructing a computer to embody the machine of the fourth aspect of the present invention.

A sixth aspect of the present invention provides a machine having a computer-readable mathematical software routine library including computer executable instructions for instructing a computer to embody the machine of the fourth aspect of the present invention.

Preferably the computer-readable mathematical software routine library of the sixth aspect of the present invention is further adapted so that the library is operatively associated with a software programming language.

### DETAILED DESCRIPTION OF THE FIGURES OF THE PRESENT INVENTION

To illustrate aspects of the present invention, the following figures are used, in which:

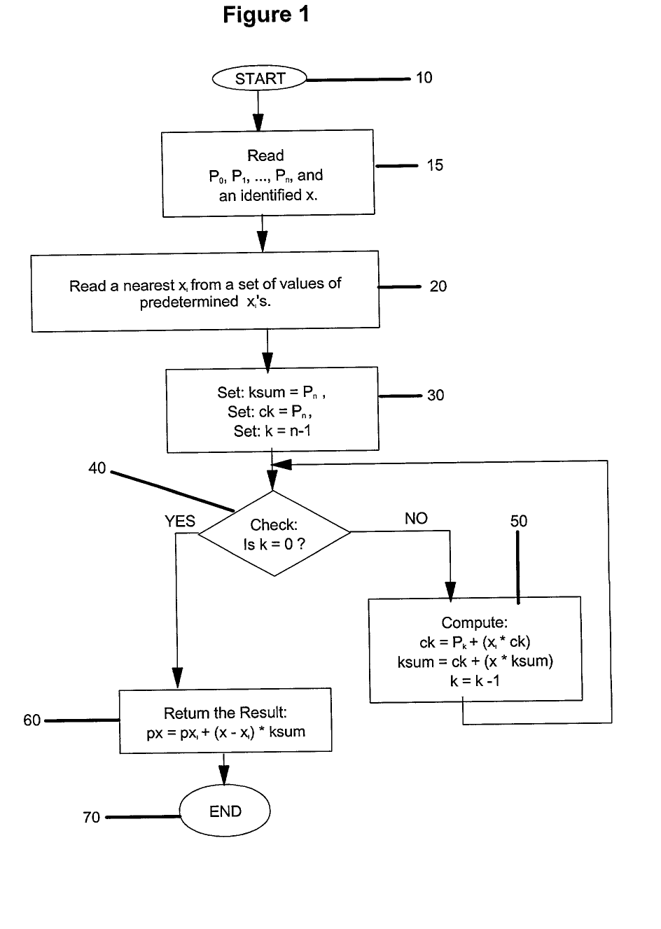

FIG. 1 depicts a programming flow chart for computing a value of a polynomial p(x) in accordance with the present invention;

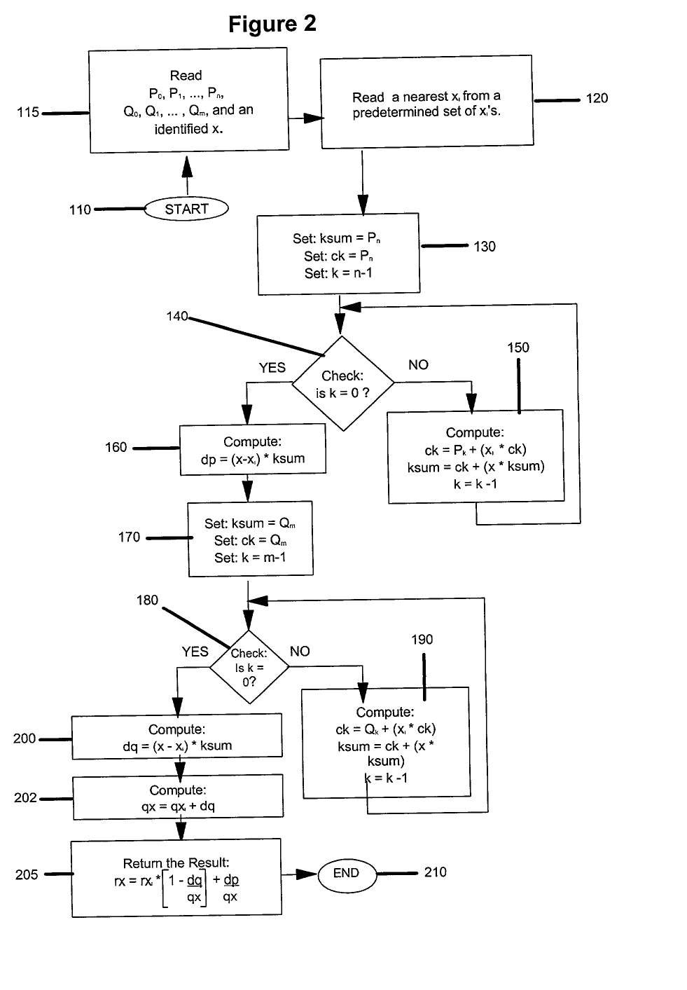

FIG. 2 depicts a programming flow chart for computing a value of a rational function p(x)/q(x) in accordance with the present invention; and

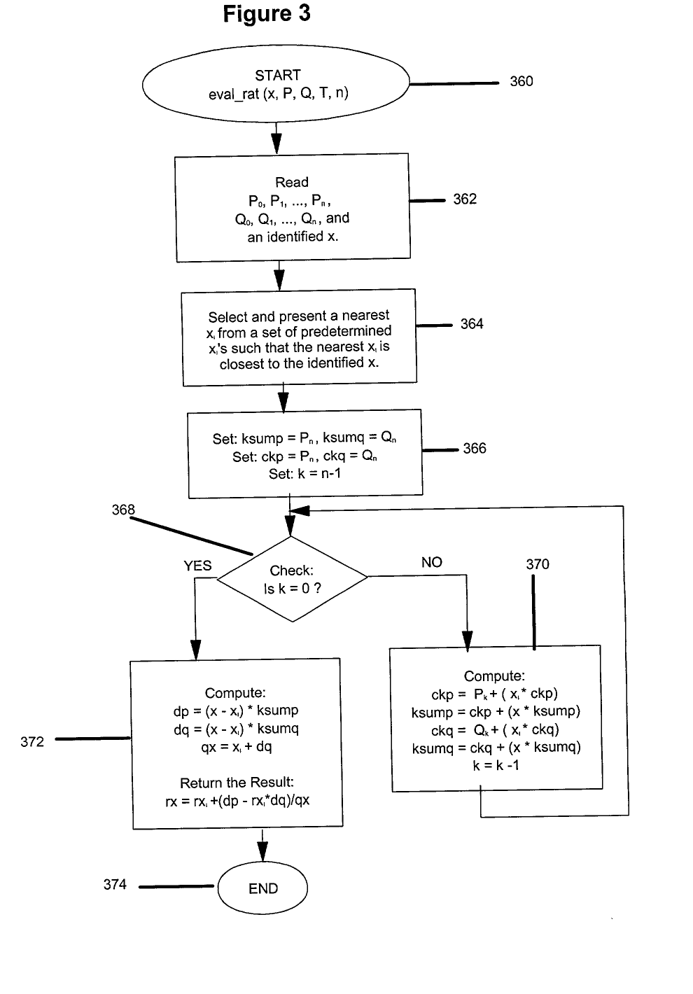

FIG. 3 depicts a programming flow chart for using a subroutine for computing a value of a Bessel function J₀(x) in accordance with the present invention.

### DETAILED DESCRIPTION OF A PREFERRED EMBODIMENT OF THE INVENTION

The present invention will be described with reference to an exemplary context of a computer processing method and apparatus for computing a binary representation of a numerical value of a polynomial p(x).

For embodiments of the present invention, references to computing or calculating values or numbers will be understood to refer to programming instructions for instructing a computer to compute binary representations of numerical values of a mathematical expression or variable. It is understood that computing machinery can manipulate and transform binary representations of numerical values or numbers.

A polynomial p(x) can be mathematically expressed as shown in the following equation:

p(x)=ΣPⱼx^{j} where j=0 to n in which p(x)=P₀+P₁·x+P₂·x²+ . . . +Pₙ·xⁿ Equ. 1

Ordered coefficients of polynomial p(x) are P₀, . . . , Pₙ. Polynomial p(x) has n+1 ordered coefficients and is said to have degree n. A numerical value of polynomial p(x) can be computed by reading each coefficient of polynomial p(x) and an identified x and using steps in Equation 1. Following Equation 1 directly would require a computer processor to perform

$$\frac{n ( n + 1 )}{2}$$

multiplications and n additions. To significantly reduce the processing time, Homer's Rule can be applied to Equation 1, in which polynomial p(x) can be expressed in Equation 1a, as shown below:

p(x)=P₀+x(P₁+x(P₂+x( . . . (Pₙ₋₁+x·Pₙ) . . . ))) Equ. 1a

By following Equation 1a, a program can perform n multiplications and n additions to compute a number for polynomial p(x) using less processing time than a program that follows Equation 1.

A polynomial p(x) at x=xᵢ can be expressed as follows:

p(xᵢ)=ΣPⱼxᵢ^{j} where j=0 to n Equ. 2

Therefore, a difference between Equation 1 and Equation 2 can be expressed as follows:

p(x)−p(xᵢ)=ΣPⱼ(x^{j}−xᵢ^{j}) where j=0 to n Equ. 3

Expanding Equation 3 can provide the following expression:

p(x)−p(xᵢ)=Σ{Pⱼ(x−xᵢ)·Σ[x^{k}·xᵢ^{(j-1-k)}]} where j=0 to n, k=0 to (j−1) Equ. 4

For Equation 4, in the first sum j=0 to n, and in the second sum k=0 to (j−1). It is appreciated that Equation 4 can be expressed as follows:

p(x)−p(xᵢ)=(x−xᵢ)·Σ{(ΣP₍ₖ₊₁₊ⱼ₎·xᵢ^{j})·x^{k}} where k=0 to (n−1), j=0 to (n−1−k) Equ. 4a

For Equation 4a, in the first sum k=0 to (n−1), and in the second sum j=0 to (n−1−k) By following Equation 4a, a value for polynomial p(x) can be computed by reading coefficients of the polynomial (P₁, P₂, . . . , Pₙ), and x, xᵢ, and p(xᵢ). Equation 4a can be expressed as a combination of Equation 5 and Equation 6,as follows:

p(x)−p(xᵢ)={x−xᵢ·}c(x)={x−xᵢ}·Σ(Cₖ·x^{k}) where k=0 to (n−1) Equ. 5

Cₖ=ΣP₍ₖ₊₁₊ⱼ₎·xᵢ^{j} where j=0 to (n−1−k) Equ. 6

Equation 5 includes an expression for a new polynomial c(x) having coefficients, from C₀, . . . , C₍ₙ₋₁₎, that are not known a priori and therefore need to be determined. Equation 6 can be used for determining values of the coefficients of new polynomial c(x) by involving the coefficients of polynomial p(x) and an identified xᵢ. Optionally, other expressions for determining values for each coefficient of new polynomial c(x) can be derived from Equation 6.

It is appreciated that Homer's Rule could be used to compute a value for polynomial c(x) after coefficients of polynomial c(x) have been computed by using Equation 6 or optionally from another expression that could be derived from Equation 6. By using Homer's Rule, Equation 5 can be expressed as follows:

p(x)−p(xᵢ)={x−xᵢ}·{C₀+x(C₁+x(C₂+x( . . . (Cₙ₋₂+x·Cₙ₋₁) . . . )))} Equ. 5a

Processing steps that follow Equation 5a begin within the innermost set of parentheses and proceed outwards to the outermost brackets. Calculated coefficients of new polynomial c(x) can subsequently be used in Equation 5a for computing a numerical value of polynomialp(x).

Optionally, unknown coefficients of new polynomial c(x) can be computed by applying the principle of mathematical recurrence on Equation 6. For example, a forward mathematical recurrence can allow computation of coefficients of polynomial c(x) by beginning with the lowest ordered coefficient, C₀, and proceeding to the highest ordered coefficient, C₍ₙ₋₁₎. Optionally, a backward mathematical recurrence can compute coefficients of polynomial c(x) by beginning with the highest ordered coefficient, C₍ₙ₋₁₎ and proceeding to the lowest ordered coefficient, C₀. With each step of backwardly computing a coefficient of polynomial c(x), a next outer most bracketed term of Equation 5a can be advantageously computed.

Optionally, a backward recurrence for determining each coefficient of new polynomial c(x) can be realized by using Equation 7 and Equation 8. Each subsequent lower-ordered unknown coefficient of new polynomial c(x) can be computed by using Equation 8.

Cₙ₋₁=Pₙ Equ. 7

Cₖ₋₁=xᵢ·Cₖ+Pₖ where k=(n−1) to 1 Equ. 8

To compute a numerical value of a polynomial p(x), a computer can read input data that includes a value for each identified ordered coefficient of the first polynomial p(x), a value of a quantity x, a value of a predetermined xᵢ, a value of a predetermined p(xᵢ) that is correspondingly paired with said predetermined xᵢ. An optional step can select a nearest xᵢ that is closest to an identified x, in which the nearest xᵢ is selected from a set of predetermined xᵢ, and a nearest predetermined p(xᵢ) corresponds to the nearest xᵢ. Optionally, coefficients of polynomial c(x) can be computed by following Equation 7 and Equation 8. A value for polynomial p(x) can then be computed by following Equation 5a. The operations of computing the coefficients of polynomial c(x) in Equation 8 can be interleaved with computing the nested parenthesis in Equation 5a so that each time a new Cₖ is computed by Equation 8 the next outer nested parenthesis of Equation 5a is computed next.

Provided p(x)−p(xᵢ) does not have a multiple root at x=xᵢ, the relative round-off error in computing p(x)−p(xᵢ) with Equation 5 can be kept small by keeping x sufficiently close to xᵢ. This can be achieved by having available a number of sufficiently closely spaced xᵢ's covering the range of x to be handled, and using the nearest xᵢ to x. To obtain a reasonable result that would be satisfactory for a given computational purpose, a difference between x and xᵢ can be sufficiently small enough to achieve a desired accuracy of a computed value of polynomial p(x).

Optionally, accuracy can be further improved by choosing xᵢ such that p(xᵢ) has extra accuracy beyond the precision of the floating-point number system of the computer. This can be achieved by selecting xᵢ to be a floating-point number, by exhaustively searching from a starting desired value for xᵢ, until an xᵢ is found for which p(xᵢ) is very close to a floating-point number (i.e. closer than half the distance between adjacent floating-point numbers). Such a floating-point approximation to p(xᵢ) has an accuracy beyond the precision of the floating-point number system.

FIG. 1 shows the preferred embodiment of the present invention, which is represented as a computer processing method embodied in a programming flow chart for computing a machine representation of a numerical value of a polynomial p(x). Optionally, coefficients of p(x) can be placed in a vector of length n. The method optionally includes a step of accessing a table having a set of predetermined values of xᵢ and a corresponding set of predetermined values of p(xᵢ) each paired with a corresponding xᵢ. A table can contain values for the following expressions:

xᵢ, p(xᵢ) for i=1 to N. Equ. 8a

In step 10, the method of the preferred embodiment begins. In step 15, each coefficient of polynomial p(x) and an identified x can be read by a computer processing unit. In step 20, the computer optionally selects a predetermined xᵢ from a set of predetermined values of xᵢ. Preferably, the predetermined xᵢis a closest member of the set to the identified x. In step 30, the initial conditions for a programming loop are set. Variable ksum is an ongoing summation that represents the sum in Equation 5a. Variable ksum is initially set equal to coefficient Pₙ of polynomial p(x). Variable ck is a temporary value for any coefficients of polynomial c(x), in which variable ck is computed to be a specific coefficient of polynomial c(x) that is determined in step 50 as will be shown below. Variable ck is initially set equal to Pₙ, which is the highest ordered coefficient of polynomial p(x). Variable k is an index counter for a processing loop, in which variable k is initially set equal to (n−1), which is one less than the degree of polynomial p(x). In step 40, a query is performed to determine whether a value for variable k is equal to zero. If the numerical value for variable k is greater than zero, the method proceeds to step 50. If the numerical value for variable k is equal to zero, the method proceeds to step 60. In step 50, a value of variable ck is computed, which is coefficient Cₖ by using the backward recurrence of Equation 8 that involves a higher ordered coefficient of polynomial p(x), which is Pₖ, and a previously determined coefficient, Cₖ₋₁, of polynomial c(x). Next, an updated value for variable ksum is computed, which is an ongoing summation of the sum in Equation 5a, by determining a sum for the next outer bracketed term of Equation 5a. For remaining iterations of step 50, the summation represented in Equation 5a progresses from an innermost set of parentheses and proceeds outwardly for each iterative step in an ongoing manner towards the outermost brackets. An updated value of variable k is computed so that the sum in Equation 5a can be resolved towards its outermost brackets. In step 60, the method uses a value for polynomial c(x), which is expressed in FIG. 1 as variable ksum after variable k equals zero in step 40. A value of polynomial p(x) is computed as a rearrangement of Equation 5a, which is expressed as

p(x)=p(xᵢ)+(x−xᵢ)*c(x).

In step 70, the method for the preferred embodiment can stop or can be repeated from step 10.

A second embodiment of the present invention provides a computer processing method for computing a machine representation of a numerical value of a rational function r(x). The rational function r(x) is expressed as a quotient of a numerator polynomial p(x) having a set of n predetermined coefficients from P₀, P₁, . . . , Pₙ, so that

p(x)=ΣPⱼ·x^{j} where j=0 to n,

and a denominator polynomial q(x) having m predetermined coefficients from Q₀, Q₁, . . . , Qₘ, so that

q(x)=ΣQⱼ·x^{j} where j=0 to m.

A rational function r(x) can be defined in the following expression:

$$r ( x ) = \frac{p ( x )}{q ( x )} \qquad \text{Equ. 8b}$$

From Equation 8b, it follows that:

$$r ( x ) = r ( {x}_{i} ) \cdot ( 1 - \frac{q ( x ) - q ( {x}_{i} )}{q ( x )} ) + \frac{p ( x ) - p ( {x}_{i} )}{q ( x )} \qquad Equ . 9$$

The second method can optionally include access to a table having a set of predetermined values of xᵢ and a corresponding set of predetermined values of q(xᵢ) each paired with a corresponding xᵢ, and a corresponding set of predetermined values of r(xᵢ) each paired with a corresponding xᵢ. It is understood that each unique xᵢ is paired with a correspondingly specific q(xᵢ, and a correspondingly specific r(xᵢ). A spacing for table values of xᵢ can be set such that a resulting absolute value of (x−xᵢ) is small enough to obtain a desired accuracy. The xᵢ spacing required for a given desired accuracy is typically estimated with a perturbation analysis (using Taylor series, for example), and verified by numerical testing. The closeness of x to xᵢ needed to achieve a given accuracy in the computed r(x) depends on the particular rational function r(x).

A table can contain values for the following expressions:

xᵢ, r(xᵢ),q(xᵢ) for i=1 to N Equ. 10

r(xᵢ) and q(xᵢ) for i=1 to N Equ. 11

Accuracy can be further improved by choosing the xᵢ's such that the following terms shown in Equation 11 can have extra accuracy beyond the precision of the floating-point number system of a computer. This can be achieved by selecting xᵢ to be a floating-point number, by exhaustively searching from a starting desired value for xᵢ, until an xᵢ is found for which so that both the quantities in Equation 11 are very close to floating-point numbers (closer than half the distance between adjacent floating-point numbers). Such floating-point approximations to r(xᵢ) and q(xᵢ) have an accuracy beyond the precision of the floating-point number system.

The second method computes values of a numerator polynomial p(x) and a denominator polynomial q(x) by following Equation 5, as follows:

p(x)−p(xᵢ)={x−xᵢ}·c(x) Equ. 12a

q(x)−q(xᵢ)={x−xᵢ}·d(x) Equ. 12

Polynomial c(x) has (n−1) unknown coefficients and polynomial d(x) has (m−1) unknown coefficients. The second method can determine coefficients of c(x) and d(x) and then determine a value for rational function r(x).

FIG. 2 shows the second embodiment of the present invention, which is represented as a computer processing method embodied in a programming flow chart for computing a computer representation of a numerical value of a rational function r(x)=p(x)/q(x). Optionally, steps for accessing a table having a set of various predetermined values for xᵢ a set of various predetermined values for q(xᵢ), and a set of various predetermined values for r(xᵢ) can be included.

In step 110, the second method begins. In step 115, a computer reads values of each coefficient of polynomial p(x) and each coefficient of polynomial q(x), and an identified x. In step 120, a predetermined xᵢ from a set of predetermined values of xᵢ can optionally be selected. Preferably, the predetermined xᵢ is a closest member of the set to the identified x. These predetermined values can be optionally stored in a table or they can be supplied to the computer in some other means. Optionally, the table includes values for various xi, various q(xi) associated with the corresponding xᵢ, and various r(xᵢ) associated with the corresponding xᵢ. Optionally, specific values for the xᵢ's, q(xᵢ)'s, and r(xᵢ)'s are chosen so that the q(xᵢ)'s and r(xᵢ)'s have extra accuracy beyond machine precision in the manner of the accurate table method that is disclosed by the prior art. It is appreciated that the computed result will be more accurate if the table has extra accuracy. Step 130, step 140, and step 150 are similar to step 30, step 40, and step 50 of FIG. 1, in that step 130, step 140, and step 150 provide a value for variable ksum to be used in step 160 as will be shown next. In step 160, a value for variable dp (i.e., delta p) is computed,which is a computed value for p(x)−p(xᵢ) for a numerator polynomialp(x). Variable dp will be used in step 205 as will be shown later. Step 170, step 180, and step 190 are similar to step 130, step 140, and step 150 of FIG. 2, in that step 170, step 180, and step 190 provide a value for variable ksum to be used in step 200 as will be shown next. In step 200 a value for variable dq (i.e., delta q), which is a computed value for q(x)−(xᵢ) for a denominator polynomial q(x) is computed. Variable dq will be used in step 202 and 205 as shown later. In step 202 a numerical value for q(x) is computed by rearranging Equation 12. In step 205 a value for a rational function r(x) is computed by following Equation 9. In step 210 the second method can stop or can be restarted from step 110.

A third embodiment of the present invention provides a computer processing method for computing binary representations of a value for a Bessel function. A programming flow chart can be developed by adapting FIG. 2 for computing a value for a Bessel function J₀(x), which is 20 a Bessel function of the first kind of order 0. The third method can be further adapted to compute a value for various Bessel functions, for example J₀, J₁, Y₀, and Y₁, over a range of x (e.g. [0,8]) by first approximating the Bessel function by a piece-wise rational function. Bessel functions can typically be approximated by rational functions having numerator and denominator polynomials with the same degree (i.e. same number of coefficients).

To compute a value of a Bessel function J₀(x) using the third method, the first task would be to determine a range that an identified x belongs in. The following is a list of steps for determining the proper range to which x belongs: if the identified x is a NAN (i.e., not a legitimate number, such as

$$\frac{0}{0}$$

or +/− INF (i.e., any non-zero number divided by zero), the method does not compute a value for the Bessel function; if the identified x is less than zero, the method makes the sign of the identified x positive; if the identified x is greater than or equal to zero and less than 3.72*10⁻⁹, then the value of the Bessel function is 1, assuming the result is returned in IEEE double-precision floating point; if the identified x is greater than or equal to 3.72*10⁻⁹ and less than 1, then the method uses a Taylor series to compute a value for the Bessel function; if the identified x is greater than or equal to 1 and less than 1.5, then the method calls a subroutine that incorporates the present invention for determining a value for the Bessel function. The subroutine will be explained in FIG. 3. In each case where the subroutine is called, arguments P, Q, T, and n of the subroutine are read along with values of x and xᵢ associated with the particular range that x belongs with; if the identified x is greater than or equal to 1.5 and less than 1.9, then the method calls the subroutine for determining a value for the Bessel function; if the identified x is greater than or equal to 1.9 and less than 2, then the method calls the subroutine for determining a value for the Bessel function; if the identified x is greater than or equal to 2 and less than 4, then the method performs steps that are beyond the scope of the present invention. The steps involve accurate evaluation of a rational approximation to J₀(x)/(x−z₀), where z₀ is the first zero of J₀; if the identified x is greater than or equal to 4 and less than 4.5, then the method calls the subroutine for determining a value for the Bessel function; if the identified x is greater than or equal to 4.5 and less than 5, then the method calls the subroutine for determining a value for the Bessel function; if the identified x is greater than or equal to 5 and less than 6, then the method performs steps that are beyond the scope of the present invention. The steps involve accurate evaluation of a rational approximation to J₀(x)/(x−z₁), where z₁ is the first zero of J₀; if the identified x is greater than or equal to 6 and 6.4, then the method calls the subroutine for determining a value for the Bessel function; if the identified x is grater than 6.4 and less than 7, then the method calls the subroutine for determining a value for the Bessel function; if the identified x is greater than or equal to 7 and less than 7.5, then the method calls the subroutine for determining a value for the Bessel function; if the identified x is greater than or equal to 7.5 and less than 8, then the method calls the subroutine for determining a value for the Bessel function; and if the identified x is greater than or equal to 8 then the method uses an asymptotic approximation for determining a value for the Bessel function, which is beyond the scope of the present invention.

FIG. 3 shows the third embodiment of the present invention, which is represented as a computer processing method embodied in a programming flow chart for computing a machine representation of a numerical value of a Bessel function J₀(x).

In step 360 a subroutine, which can be called eval_rat, of the flow chart of the third embodiment begins. The subroutine inputs an argument x, at which the value of a rational function is desired to be computed, and P and Q, which are vectors containing the coefficients of the numerator and denominator polynomials p(x) and q(x), respectively, of the rational function, and T, which is a table containing a set of predetermined xᵢ's and corresponding r(xᵢ)'s and q(xᵢ)'s, and n, which is the degree of p(x) and q(x). In step 362 a computer processing unit reads values for each coefficient of numerator polynomial p(x) and denominator polynomial q(x), in which both polynomials have the same number or coefficients, and also reads an identified x. In step 364, to achieve improved performance, a nearest xᵢ and other required data are optionally read from a table. In step 366 various variables are initialized for subsequent use in an instruction loop. One software loop is used because the numerator and the denominator polynomials have the same degree (that is, share the same number of coefficients). This loop is similar to a combination of the two loops involving steps 130 to 150 and 170 to 190 in FIG. 2. In step 368, a test determines whether the loop has been completed. In step 370, variables are computed in a manner similar to that combining steps 150 and 190 in FIG. 1. In step 372, variables are computed in a manner similar to that combining steps 160 and 200 to 205 shown in FIG. 1. Step 374 marks the end of the subroutine of the flow chart of the third embodiment.

For non-elementary special functions, for example the error function (ERF), the complementary error function (ERFC), or the Bessel functions,range-reduction properties, such as those available for the elementary functions, are not known. To directly apply prior art table-driven techniques, for example those used for the elementary functions, for these non-elementary special functions, would require a computer processing unit to read coefficients of each of a large number of polynomials, one associated with each table point. This can make the table unacceptably large.

Computing steps that embody the methods of the present invention can be used to determine values for polynomials or rational functions approximating the non-elementary special function. Optionally, coefficients of a polynomial or rational function associated with each individual table point, xᵢ, do not have to be stored; instead, these coefficients can be computed using simple formulas from only one (for polynomials) or two (for rational functions) stored function values per table point, resulting in tables of manageable size. In this sense, the present invention provides a benefit similar to that of range reduction formulas, for functions for which range reduction formulas do not exist.

Mathematical software libraries, including those associated with a software programming language or operating system, can be adapted to instruct a general purpose digital computer to embody the present invention. It is appreciated that a software does not necessarily have to belong to a programming language or operating system. There are also stand-alone libraries of mathematical routines, for example, the IBM™ Engineering and Scientific Subroutine Library, ESSL™.

There are many examples that illustrate the practical application of the present invention for mathematically modelling a property of a physical system. C. M. Close in “The Analysis of Linear Circuits”, Harcourt, Brace & World (1966), discloses in Chapters 6 and 11 the use of polynomials for determining frequency response characteristics of electrical systems. The same concepts can be applied to non-electrical systems, such as mechanical, hydraulic, acoustical, and thermal systems. R. C. Weyrick in “Fundamentals of Automatic Control”, McGraw-Hill Book Company (1975), discloses in Chapters 2 and 6 the use of polynomials for mathematically modelling physical systems for predicting a behavior of a physical system. D. Halliday and R. Resnick in “Physics: Parts 1 and 2”, John Wiley & Sons (1978) disclose in Chapters 3 and 4 the use of polynomials for mathematically modelling and predicting spatial co-ordinates of impact of a projectile being released from an aeroplane.

The present invention can be implemented in a computer-readable computer memory program having a medium for storing and carrying the program to a general purpose computer for instructing a computer processing unit to implement the embodiments of the present invention. A computer-memory product can be a floppy disk or compact disk that can be adapted to carry software that tangibly embodies the present invention.

A computer processing method that tangibly embodies the present invention can be used for computing a number for a mathematical model and for comparing the computed number against an observed behaviour of a physical phenomenon.

The concepts of the present invention can be further extended to a variety of other applications that are clearly within the scope of this invention.

Having thus described the present invention with respect to a preferred embodiment as implemented, it will be apparent to those skilled in the art that many modifications and enhancements are possible to the present invention without departing from the basic concepts as described in the preferred embodiment of the present invention. Therefore, what is intended to be protected by way of letters patent should be limited only by the scope of the following claims.

The embodiments of the invention in which an exclusive property or privilege is claimed are defined as follows:

1. A machine-processing method for computing a property of a mathematically modelled physical system, the steps comprising:
a) reading, via a machine processing unit, input data including a value for each identified ordered coefficient of a first polynomial p(x) representing said property, said polynomial p(x) being expressed as
p(x)=Σ(Pⱼ·x^{j}) where j=0 to n,
a value of a quantity x, a value of a predetermined xᵢ, and a value of a predetermined p(xᵢ) correspondingly paired with said predetermined xᵢ;
b) building, via said machine processing unit, a value of a second polynomial c(x) having ordered coefficients, said second polynomial c(x) being expressible as:
C(x)=Σ(Cₖ·x^{k}) where k=0 to (n−1)
so that said first polynomial p(x) is expressible as:
p(x)=p(xᵢ)+{x−xᵢ}·c(x),
comprising the steps of:
i) determining, via said machine processing unit, a value for each ordered coefficient of said second polynomial c(x) by generating a plurality of machine processing unit signals to determine each said ordered coefficient of said second polynomial c(x) from:
Cₖ=Σ(P₍ₖ₊₁₊ⱼ₎·xᵢ^{j}) where j=0 to (n−1−k);
ii) determining, via said machine processing unit, a value of said second polynomial c(x) by generating a plurality of machine processing unit signals to determine:
C(x)=Σ(Cₖ·x^{k}) where k=0 to (n−1);
c) constructing, via said machine processing unit, a value of said first polynomial p(x) by generating a plurality of machine processing unit signals to determine:
p(x)=p(xᵢ)+{x−xᵢ}·c(x);
and
d) outputting, via said machine-processing unit, said value of the first polynomial p(x) representing said property of the mathematically modelled physical system.

2. The machine-implementable method of claim 1, wherein a difference between x and xᵢ is sufficiently small to achieve a desired accuracy of a final computation of said machine representation of a numerical value of said first polynomial p(x).

3. The machine-implementable method of claim 2 wherein the step of reading said input data comprises reading, via said machine processing unit, said input data from a machine-readable medium.

4. The machine-implementable method of claim 3 wherein said ordered coefficients of said second polynomial c(x) are computed from a mathematical expression derivable from:
Cₖ=Σ(P₍ₖ₊₁₊ⱼ₎·xᵢ^{j}) where j=0 to (n−1−k).

5. The machine-implementable method of claim 4 wherein said mathematical expression is a mathematical recurrence expression.

6. The machine-implementable method of claim 5 wherein said mathematical recurrence expression is a forward mathematical recurrence expression.

7. The machine-implementable method of claim 5 wherein said mathematical recurrence expression is a backward mathematical recurrence expression.

8. The machine-implementable method of claim 7 further adapted to implement said backward mathematical recurrence expression by comprising further steps for:
e) equating, via said machine-processing unit, a value of a highest ordered coefficient of said second polynomial c(x) to a value of an identified highest ordered coefficient of said first polynomial p(x) by generating a plurality of machine processing unit signals to determine:
Cₙ₋₁=Pₙ;
and
f) computing, via a machine processing unit, a value for each lower ordered coefficient of said second polynomial c(x) by generating a plurality of machine processing unit signals to determine:
Cₖ₋₁=xᵢ·Cₖ+Pₖ where k=(n−1) to 1.

9. The machine-implementable method of claim 8 wherein said predetermined xᵢ is selected from a set of predetermined values of xᵢ.

10. The machine-implementable method of claim 9 wherein said predetermined xᵢ is a closest member of said set to said identified x.

11. The machine-implementable method of claim 10 wherein said step of determining a value of said second polynomial c(x) is computed by using Homer's Rule.

12. The machine-implementable method of claim 11 for determining a value of a denominator polynomial q(x) having identified ordered denominator coefficients, said denominator polynomial q(x) being expressible as:
q(x)=Σ(Qⱼ·x^{j}) where j=0 to m,
comprising further steps of:
g) adapting said input data to further include a value for each identified ordered denominator coefficient of said denominator polynomial q(x), a value of a predetermined q(xᵢ) correspondingly paired with said predetermined xᵢ; and
h) determining, via said machine processing unit, a value of another polynomial d(x) having ordered denominator coefficients, said another polynomial d(x) being expressible as:
d(x)=Σ(Dₖ·x^{k}) where k=0 to (m−1)
so that said denominator polynomial q(x) is expressible as:
q(x)=q(xᵢ)+{x−xᵢ}·d(x),
and a value for the said denominator polynomial is resolved.

13. The machine-implementable method of claim 12 wherein the first polynomial p(x) is a numerator polynomial p(x), and p(x)−p(xᵢ) is computed, and p(xᵢ) is not read.

14. The machine-implementable method of claim 13 for determining a value of a rational function r(x) being expressible as a quotient of said numerator polynomial p(x) and said denominator polynomial q(x) expressed as
$$r ( x ) = \frac{p ( x )}{q ( x )} ,$$
comprising further steps of:
i) adapting said input data to further including a value of a predetermined r(xᵢ) correspondingly paired with said predetermined xᵢ; and
j) constructing, via said machine processing unit, a value of said rational function r(x) by generating a plurality of machine processing unit signals to determine:
$$r ( x ) = r ( {x}_{i} ) \cdot ( 1 - \frac{q ( x ) - q ( {x}_{i} )}{q ( x )} ) + \frac{p ( x ) - p ( {x}_{i} )}{q ( x )} .$$

15. The machine-implementable method of claim 14 wherein said rational function r(x) is an approximation to a Bessel function.

16. The machine-implementable method of claim 14 wherein said rational function r(x) is an approximation to an error function (ERF).

17. The machine-implementable method of claim 14 wherein said rational function r(x) is an approximation to a complementary error function (ERFC).

18. The machine-implementable method of claim 14 wherein said rational function r(x) is an approximation to a log gamma function (LGAMMA).

19. The machine-implementable method of claim 11 or 14 wherein all values are machine representations of some numerical value, said machine processing unit is a computer processing unit, each machine representation is a binary representation operable with said computer processing unit, and machine-readable medium is a computer-readable medium.

20. A computer-readable program product having computer executable instructions for instructing a computer, said instructions tangibly embodying the machine-implementable method of claim 19.

21. A computer-readable mathematical software routine library including computer executable instructions for instructing a computer, said instructions tangibly embodying the is machine-implementable method of claim 19.

22. The computer-readable mathematical software routine library of claim 21 wherein said library is operatively associated with a software programming language.

23. A machine for computing a property of a mathematically modelled physical system, the steps comprising:
a) reading, via a machine processing unit, input data including a value for each identified ordered coefficient of a first polynomial p(x) representing said property, said polynomial p(x) being expressed as
p(x)=Σ(Pⱼ·x^{j}) where j=0 to n,
a value of a quantity x, a value of a predetermined xᵢ, and a value of a predetermined p(xᵢ) correspondingly paired with said predetermined xᵢ;
b) building, via said machine processing unit, a value of a second polynomial c(x) having ordered coefficients, said second polynomial c(x) being expressible as:
c(x)=Σ(Cₖ·x^{k}) where k=0 to (n−1)
so that said first polynomial p(x) is expressible as:
p(x)=p(xᵢ)+{x−xᵢ}·c(x),
comprising the steps of:
i) determining, via said machine processing unit, a value for each ordered coefficient of said second polynomial c(x) by generating a plurality of machine processing unit signals to determine each said ordered coefficient of said second polynomial c(x) from:
Cₖ=Σ(P₍ₖ₊₁₊ⱼ₎·xᵢ^{j}) where j=0 to (n−1−k);
ii) determining, via said machine processing unit, a value of said second polynomial c(x) by generating a plurality of machine processing unit signals to determine:
c(x)=Σ(Cₖ·x^{k}) where k=0 to (n−1);
c) constructing, via said machine processing unit, a value of said first polynomial p(x) by generating a plurality of machine processing unit signals to determine:
p(x)=p(xᵢ)+{x−xᵢ}·c(x);
and
d) outputting, via said machine-processing unit, said value of the first polynomial p(x) representing said property of the mathematically modelled physical system.

24. The machine of claim 23 wherein a difference between x and xᵢ is sufficiently small to achieve a desired accuracy of a final computation of said machine representation of a numerical value of said first polynomial p(x).

25. The machine of claim 24 wherein said means for reading said input data comprises means for reading, via said machine processing unit, said input data from a machine-readable medium.

26. The machine of claim 25 wherein said ordered coefficients of said second polynomial c(x) are computed from a mathematical expression derivable from:
Cₖ=Σ(P₍ₖ₊₁₊ⱼ₎·xᵢ^{j}) where j=0 to (n−1−k).

27. The machine of claim 26 wherein said mathematical expression is a mathematical recurrence expression.

28. The machine of claim 27 wherein said mathematical recurrence expression is a forward mathematical recurrence expression.

29. The machine of claim 27 wherein said mathematical recurrence expression is a backward mathematical recurrence expression.

30. The machine of claim 29 further adapted to implement said backward mathematical recurrence expression by further comprising:
e) means for equating, via said machine processing unit, a value of a highest ordered coefficient of said second polynomial c(x) to a value of an identified highest ordered coefficient of said first polynomial p(x) by generating a plurality of machine processing unit signals to determine:
Cₙ₋₁=Pₙ;
and
f) means for computing, via said machine processing unit, a value for each lower ordered coefficient of said second polynomial c(x) by generating a plurality of machine processing unit signals to determine:
Cₖ₊₁=xᵢ·Cₖ+Pₖ where k=(n−1) to 1.

31. The machine of claim 30 wherein said predetermined xᵢ is selected from a set of predetermined values of xᵢ.

32. The machine of claim 30 wherein said predetermined xᵢ is a closest member of said set to said identified x.

33. The machine of claim 32 wherein the determining means for determining a value of said second polynomial c(x) is computed by using Homer's Rule.

34. The machine of claim 33 for determining a value of a denominator polynomial q(x) having identified ordered denominator coefficients, said denominator polynomial q(x) being expressible as:
q(x)=Σ(Qⱼ·xⱼ) where j=0 to m,
comprising further steps of:
g) adapting said input data to further include a value for each identified ordered denominator coefficient of said denominator polynomial q(x), and a value of a predetermined q(xᵢ) correspondingly paired with said predetermined xᵢ; and
h) determining, via said machine processing unit, a value of another polynomial d(x) having ordered denominator coefficients, said another polynomial d(x) being expressible as:
d(x)=Σ(Dₖ·x^{k}) where k=0 to (m−1)
so that said denominator polynomial q(x) is expressible as:
q(x)=q(xᵢ)+{x−xᵢ}·d(x),
and a value for the said denominator polynomial is resolved.

35. The machine of claim 34 wherein the first polynomial p(x) is a numerator polynomial p(x), and p(x)−p(xᵢ) is computed, and p(xᵢ) is not read.

36. The machine of claim 35 for determining a value of a rational function r(x) being expressible as a quotient of said numerator polynomial p(x) and said denominator polynomial q(x) expressed as
$$r ( x ) = \frac{p ( x )}{q ( x )} ,$$
comprising further steps of:
i) adapting said input data to further including a value of a predetermined r(xᵢ) correspondingly paired with said predetermined xᵢ; and
j) constructing, via said machine processing unit, a value of said rational function r(x) by generating a plurality of machine processing unit signals to determine:
$$r ( x ) = r ( {x}_{i} ) \cdot ( 1 - \frac{q ( x ) - q ( {x}_{i} )}{q ( x )} ) + \frac{p ( x ) - p ( {x}_{i} )}{p ( x )} .$$

37. The machine of claim 36 wherein said rational function is an approximation to a Bessel function.

38. The machine of claim 36 wherein said rational function is an approximation to an error function (ERF).

39. The machine of claim 36 wherein said rational function is an approximation to a complementary error function (ERFC).

40. The machine of claim 36 wherein said rational function is an approximation to a log gamma function (LGAMMA).

41. The machine of claim 33 or 36 wherein all values are machine representations of some numerical value, said machine processing unit is a computer processing unit, each machine representation is a binary representation operable with said computer processing unit, and said machine-readable medium is a computer-readable medium.

42. A machine having a computer-readable program product having computer executable instructions for instructing a computer to embody the machine of claim 41.

43. A machine having a computer-readable mathematical software routine library including computer executable instructions for instructing a computer to embody the machine of claim 41.

44. A machine having the computer-readable mathematical software routine library of claim 43 wherein said library is operatively associated with a software programming language.
